(19) United States
(12) Patent Application Publication
(10) Pub. No.: US 2024/0403598 A1
(43) Pub. Date: Dec. 5, 2024

(54) PARALLELIZATION PLAN GENERATION FOR A NEURAL NETWORK

(71) Applicant: Microsoft Technology Licensing, LLC, Redmond, WA (US)

(72) Inventors: Youshan MIAO, Beijing (CN); Fan YANG, Beijing (CN); Quanlu ZHANG, Beijing (CN); Saeed MALEKI, Redmond, WA (US); Xu CAO, Beijing (CN); Yi ZHU, Beijing (CN); Mao YANG, Beijing (CN); Lidong ZHOU, Beijing (CN); Zhiqi LIN, Beijing (CN)

(21) Appl. No.: 18/327,821

(22) Filed: Jun. 1, 2023

(51) Int. Cl. G06N 3/04

(52) U.S. Cl. CPC G06N 3/04

(57) ABSTRACT

Embodiments of the present disclosure include techniques for designing and generating a parallelization plan for a neural network so that workloads in the neural network may be split amongst multiple devices. Operators and tensors in the neural network are transformed into a set of functionally equivalent operators and tensors. These functionally equivalent operators and tensors are then scheduled to separate devices for execution.

### BACKGROUND

The present disclosure relates generally to computing systems. More particularly, the present disclosure relates to techniques for generating parallelization plans for neural network models.

A neural network is a machine learning model used for a variety of different applications (e.g., image classification, computer vision, natural language processing, speech recognition, writing recognition, etc.). A neural network may be trained for a particular purpose by running datasets through it, comparing results from the neural network to known results, and updating the network based on the differences.

Deep neural networks (DNNs) have grown exponentially in size over the past years in order to achieve better accuracies. Despite their high accuracies, DNNs typically need significant computational cost both in training and inference. A single computing system's memory has not scaled as fast as the model sizes so therefore large DNN models cannot fit into a single GPU accelerator due to limited available memory. Therefore, utilizing parallel GPUs to distribute a model's weights is one technique to enable training of such large models.

### BRIEF DESCRIPTION OF THE DRAWINGS

FIG. 1 illustrates a system for generating a parallelization plan for a neural network model according to some embodiments.

FIG. 2 illustrates a process for generating a parallelization plan for a neural network according to some embodiments.

FIG. 3 illustrates workflow 300 describing the overall workflow of a PPG according to some embodiments.

FIG. 4 illustrates an example of virtual tensors before and after an operator transform according to some embodiments.

FIG. 5 illustrates a process of tracking data dependency after two op-trans according to some embodiments.

FIG. 6 illustrates an example of generating a dependency graph according to some embodiments.

FIG. 7 illustrates a process of data dependency materialization according to some embodiments.

FIG. 8 illustrates communication primitives with producers and consumers on the same group of devices according to some embodiments.

FIG. 9 illustrates an example that connects the producer R(1)V(2)D(1,2) to the consumer R(2)V(1)D(2,1).

FIG. 10 depicts a simplified block diagram of an example computer system.

### DETAILED DESCRIPTION

Described herein are techniques for designing and generating a parallelization plan for a NN model. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein. Although many of the embodiments described herein will reference DNN models, it is to be understood by those skilled in the art that these techniques may be applied to different types of DNN, artificial neural networks (ANN), convolutional neural networks (CNN), as well as other types of neural networks (NN).

In some embodiments, a computing system is configured to generate a parallelization plan for a NN, such as a DNN. With the growing model size, DNNs are commonly trained over multiple computing devices that belong to an execution environment. These multiple computing devices may be a central processing unit (CPU), a graphics processing unit (GPU), other processor, or a combination of the above such as a GPU accelerator which is a combination of a GPU in addition to a CPU. In some embodiments, the computing system generates the parallelization plan based on a data flow graph (DFG) representation of the NN model. The parallelization plan may first transform the DFG into fine-grained tasks and then schedule these tasks to the multiple computing devices within the execution environment for execution. This transformation and scheduling of the DFG on multiple computing devices is a parallelization plan. The DFG may express the architecture of a NN model in terms of operators such as matrix multiplication. Each node in the DFG is an operator and each edge corresponds to the input and output data for each node. In some embodiments, each edge is a tensor capable of storing data that is output from one operator and used as input to another operator. The computing system may generate a parallelization plan in the form of a transformed DFG where the transformed DFG contains partitioned operators that may be assigned to different computing devices in the execution environment.

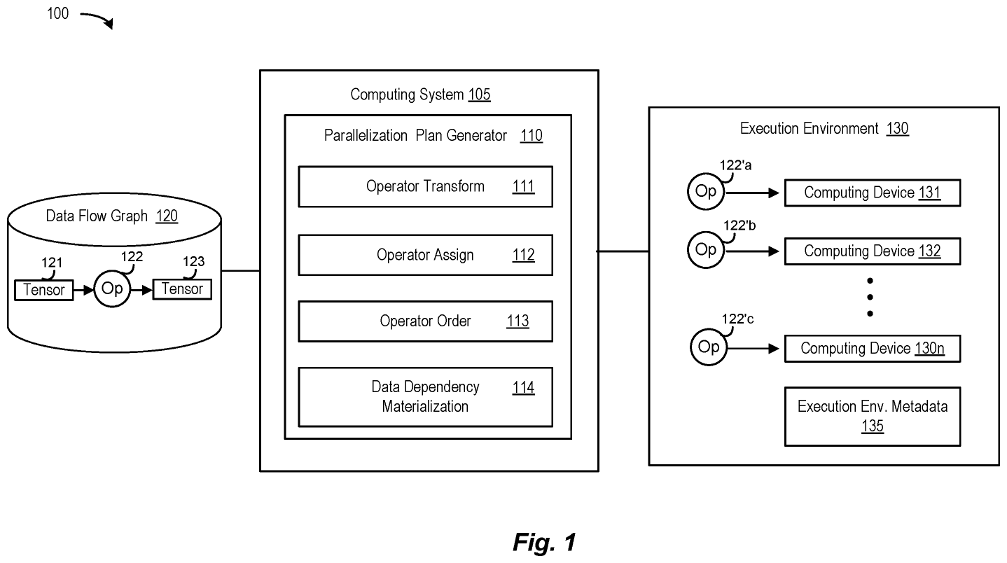

FIG. 1 illustrates system 100 for generating a parallelization plan for a NN model according to some embodiments. As shown, system 100 includes computing system 105, DFG 120, and execution environment 130. Computing system 105 is configured to execute parallelization plan generator (PPG) 110 which is an application either stored locally on computing system 105 or stored externally but accessible by computing system 105. PPG 110 may include functions, also known as primitives, that can be executed to generate parts of the parallelization plan. As shown in FIG. 1, these functions can include operator transform (“op-trans”) 111, operation assign (“op-assign”) 112, operation order (“op-order”) 113, and data dependency materialization 114. These functions will be described in further detail below. As described herein, PPG 110 can help developers to design and generate flexible parallelization plans for deep learning training. Departing from empirical solutions, PPG 110 takes a principled approach that formulates the design of parallelization plan as three sequential phases explicitly: model partitioning (op-trans 111), space-time scheduling (op-assign 112 and op-order 113), and data dependency materialization 114.

In the model partitioning phase, PPG 110 provides op-trans 111. Op-trans 111 may be a primitive that allows a developer to express model partitioning as the transformation of one or more operators in the DFG representing the NN model. The developer can provide multiple transformations for one operator, and PPG 110 can compose them into graph-level transformation. Given a transformed graph (a.k.a. partitioned model), PPG 110 moves to the scheduling phase in which it provides op-assign 112 and op-order 113 primitives for developers to express various spacetime scheduling schemes, with op-assign 112 mapping a portion of partitioned model to a certain GPU spatially, and op-order 113 expressing a happen-before constraint to enforce the temporal execution order between operators without explicit data dependency. These two phases allow developers to consider transformation and scheduling, separately which enables the expression of flexible parallelization plans which is different than existing solutions.

In some embodiments, the flexibility enabled by the separation between model partitioning and scheduling may increase the burden of developers as the transformation and scheduling process could be error-prone. The transformation may require sophisticated changes in data dependencies to preserve the correct mapping between transformed and original DFGs. For example, one may accidentally specify temporal scheduling order that violates data dependencies and leads to deadlocks. To address this problem, PPG 110 introduces vTensor to track the logical data dependencies before and after each operator transformation, and maintains the dependencies between transformed operators through the original DFG. After scheduling decision is made, PPG 110 performs deadlock detection through the analysis of the tracked data dependency, and alerts the developers of potential violation so that they can refine the design accordingly. The process repeats iteratively until no violation is detected. This facilitates the reasoning of various parallelization plans during the design process.

PPG 110 provides data dependency materialization 114 to automatically materialize the logical data dependency tracked during graph transformation and scheduling. The dependency materialization automatically inserts a collective communication primitive such as all-reduce for an operator that is split and scheduled across GPUs. These communication primitives can have unconventional semantics if two dependent operations are assigned to two different number of GPUs. The automatic data dependency materialization and communication operation insertion may relieve developers from the tedious and error-prone process of exploring parallelization plans.

With the above design, PPG 110 decouples multiple seemingly intertwined factors and enables developers to design different parallelization plans without worrying about the underlying system implementation details.

Back to FIG. 1, PPG 110 is configured to receive DFG 120. DFG 120 is a graphical representation of a NN model that consists of operators as the nodes of the graph and data tensors as the edges of the graph. A data tensor is a container which can store or hold data in one or more dimensions. Here, data tensor 121 is an input to operator 122 and data tensor 123 is an output to operator 122. In some embodiments, PPG 110 is configured to transform an operator in DFG 120 into a set of functionally equivalent operators so that each of the functionally equivalent operators can be assigned to different computing devices in the execution environment to take advantage of parallelism. For example, given that matrix A and matrix B can be split into {a1,a2] and [b1,b2]\hat{ }T, then their matrix multiplication A*B is equivalent to a1*b1+a2*b2. PPG 110 may transform one or more operators of DFG 120 into a set of partitioned operators. In one example, all operators within DFG 120 are evaluated for transformation. As shown in FIG. 1, PPG 110 transforms operator 122 into operators 122′a, 122′b, and 122′c. These three operators, in combination, are functionally equivalent to operator 122. However, since they are three distinct operators, PPG 110 may assign operator 122′a to computing device 131, assign operator 122′b to computing device 132, and assign operator 122′c to computing device 130n. In one embodiment, PPG 110 evaluates the computing devices in execution environment 130 to determine which computing devices have availability to execute the operator. PPG 110 may assign the partitioned operators to computing devices in execution environment 130 based on their availability. In one embodiment, the number of partitioned operators that are generated from a given operator is based on the availability of the computing devices in the execution environment. In another embodiment, the number of partitioned operators that are generated from a given operator is based on execution environment metadata 135. In yet other embodiments, the decision on how to partition the operator may be based on the developer's preference. The developer may specify the number of partitions according to the number of available devices in the environment, the execution metadata, or other sources. For example, PPG 110 may discover from execution environment metadata 135 that execution environment 130 contains n computing devices and in turn may transform an operator into a set of n partitioned operators. In some embodiments, execution environment metadata 135 can include a count of the total number of computing devices within the execution environment that are capable of executing a portion of the NN model, hardware information describing the capabilities of the computing devices, or config information describing the configurations of the computing devices. This information may be used by PPG 110 to determine how to translate one or more operators in the DFG.

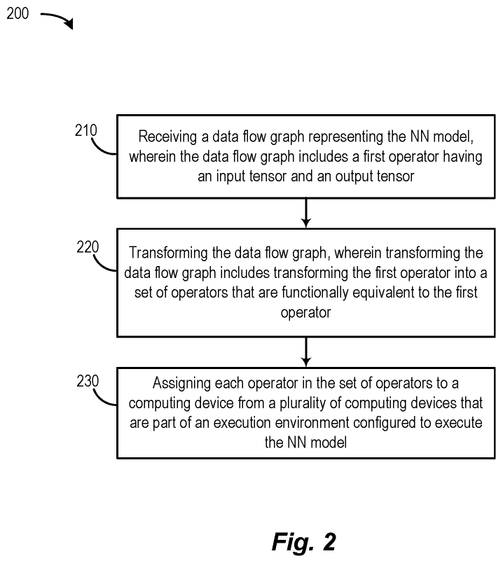

FIG. 2 illustrates a process for generating a parallelization plan for a NN model according to some embodiments. Process 200 can be stored as a computer program in non-transitory computer-readable medium to be executed by one or more processors. For example, process 200 can be executed by one or more processors of computing system 105 of FIG. 1. Process 200 begins by receiving a DFG representing the NN model at 210. The DFG is a graphical representation of the NN model and includes a first operator having an input tensor and an output tensor.

Process 200 then continues by transforming the DFG into a transformed DFG at 220. Transforming the DFG includes transforming the first operator into a set of operators that are functionally equivalent to the first operator. In some embodiments, transforming the DFG also includes generating virtual tensors that link to a persistent tensor in the NN model. The persistent tensor in the NN model may be an edge connected to a node representing the first operator. Virtual tensors are able to track data tendency during the transformation without risk of modifying the original NN model. Each virtual tensor also maintains a mask representing which portion of the persistent tensor that the operator accesses during its calculation. By keeping track of which portions are the persistent tensor are accessed during execution of the operator, data dependencies during operator transformations. In some embodiments, these data dependencies may trigger the order in which the operators are performed. In other embodiments, these data dependencies may trigger copying of tensor data between computing devices so that a given computing device has the data necessary to execute an operator.

Process 200 then continues by assigning each operator in the set of operators to a computing device from a plurality of computing devices that are part an execution environment configured to execute the NN model at 230. The execution environment for the NN model includes multiple computing devices. In one embodiment, process 200 may assign each operator in the set of operators to a different computing device. For example, if the there are three partitioned operators in the set of operators, process 200 may assign the first partitioned operator to a first computing device, the second partitioned operator to a second computing device, and the third partitioned operator to a third computing device. In one embodiment, process 200 may first determine which computing devices within the execution environment have bandwidth to execute a partitioned operator before assigning the partitioned operators. In other embodiments, other load balancing algorithms may be used when assigning partitioned operators to computing devices. For example, the execution environment may contain five computing devices when process 200 is attempting to assign three partitioned operators. Process 200 may utilize load balancing algorithms or check bandwidth of the computing devices when assigning the three partitioned operators.

In some embodiments, frameworks such as PyTorch and TensorFlow may be utilized to express the architecture of a DNN in terms of basic operators such as matrix multiplication. Composing these operators creates a data flow graph (DFG) which is a directed acyclic graph (DAG) and each node is a basic operator and every edge corresponds to the data dependency between the source and the destination. A DNN framework takes the DFG as an input and computes the operators following DFG dependencies. For a given model, this DFG is executed numerous times each with a different input and the model weights are updated with every few iterations.

The corresponding DFG for a large model may have large operators and a large graph. Therefore, partitioning large operators into multiple smaller independent operators and then assigning them to different computing devices may be more efficient. We call the end-to-end scheme of partitioning and scheduling the DFG on multiple computing devices a parallelization plan.

In one embodiment, PPG 110 is implemented based on PyTorch. Developers use PPG 110's primitives, op-trans, op-assign and op-order, to write a program describing how a given DNN model, represented by a DFG, is transformed and scheduled. PPG 110 then compiles the program into an execution flow graph served as an intermediate representation of the parallelization plan. PPG 110 analyzes this graph for automatic data dependency materialization and deadlocks detection. Finally, the resulting graph is compiled back into PyTorch codes for execution via a PyTorch engine.

The flexibility of PPG 110 offers easy exploration of new parallelization plans such as co-shard and interlaced pipeline besides existing empirical plans. This is made possible by PPG 110's flexible space-time scheduling and materialization of data dependency leveraging unconventional communication patterns. The resulting parallelization plans are shown to achieve 3.5× speedup compared to state-of-the-art parallel training systems, including DeepSpeed, Megatron and Alpa, for emerging DNN models in computer vision (Swin-Transformer), language translation (mBART), and biology analysis (AlphaFold2). To support more flexible parallelization plans, PPG 110 allows developers to focus on model partitioning and space-time scheduling, while delegating the sophisticated, error-prone process of data dependency materialization to PPG 110.

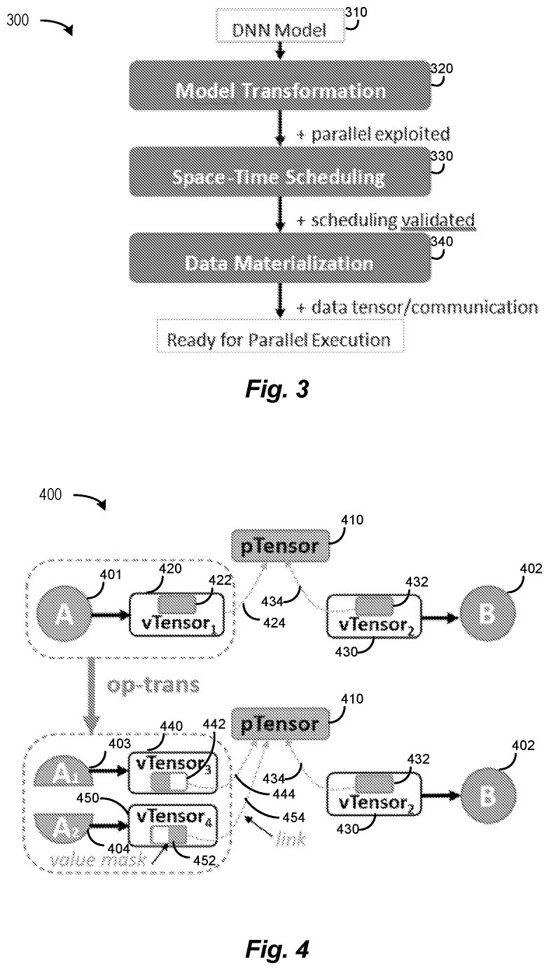

FIG. 3 illustrates workflow 300 describing the overall workflow of a PPG according to some embodiments. The input of workflow is DNN model 310, or a DFG of DNN model 310. Besides DNN model, developers also provide a program that express a parallelization plan with primitives op-trans, op-assign and op-order. PPG first exploits inherent parallel of DNN model 310 by applying op-trans to partition operators into multiple functional equivalent operators as part of model transformation 320. PPG also tracks the data relations during model transformation 320. Then, PPG performs space-time scheduling 330 with primitive op-assign assigning each operator an execution device and op-order that enforces execution orders between operators. PPG also builds data dependency from tracked data relation to validate scheduling and avoid possible deadlock. Finally, PPG materializes the tracked data dependency into communications that connect mismatched data partitioning and cross device operators, and generates parallel execution during data materialization 340.

### Op-Trans

NN models, defined as operators performing computation over high dimensional tensor data, can be partitioned into finer-grain tasks to exploit parallelism. In one embodiment, PPG performs such operation over each operator om the DFG with op-trans. In other embodiments, PPG performs such operation over a subset of the operators in the DFG. Following a user-defined transformation algorithm algo, an op-trans (op, algo) partitions an operator op into a set of functional equivalent operators. In some embodiments, op-trans also partitions an operator along with its input and output data tensors into a set of functionally equivalent tensors.

vTensor

In some embodiments, PPG can generate a virtual tensor (vTensor) to track the changing data dependency during operator transformation. FIG. 4 illustrates an example of virtual tensors before and after an operator transform according to some embodiments. A vTensor “links” to a pTensor, which is a logically persistent tensor defined in the original NN model. Besides the link, a vTensor also maintains a “mask”, representing which portion of the pTensor the operator accesses. Each operator has their own dedicated input and output vTensors, even multiple operators access the same pTensor.

As shown on the top of FIG. 4, operator A 401's output data is also operator B 402's input. The two operators are linked to the same pTensor 410 through their own vTensors, respectively. Operator A 401 has vTensor1 420 as its output data and operator B 402 has vTensor2 430 as its input data. Leveraging vTensor, a transformation algorithm in op-trans is defined as a graph substitution, which describing: 1) each new operator's computation, e.g., MatMul, Add, and 2) how to partition original input and output vTensors to get new operators' input and output vTensors. When applying an op-trans, PPG partitions vTensors and leaves pTensor 410 unchanged. This preserves the original data in the DFG since other operators may utilize pTensor 410. Also, op-trans over an operator won't affect other operators' vTensors, as different operators have dedicated vTensors. As shown in FIG. 4, applying op-trans on operator A 401 only splits itself and its output vTensor 420, leaving operator B 402 unchanged (operator B 402 and its corresponding vTensor 430 have remained unchanged). Operator A 401 has been split into partitioned operator A1 403 and partitioned operator A2 404. Operator A 401 is functionally equivalent to the combination of partitioned operator A1 403 and partitioned operator A2 404. Partitioned operator A1 403 has vTensor3 440 as its output data. vTensor3 440 includes mask 442 that represents which portion of pTensor 410 that partitioned operator A1 403 accesses and link 444 to pTensor 410. Similarly, partitioned operator A2 404 has vTensor4 450 as its output data. vTensor4 450 includes mask 452 that represents which portion of pTensor 410 that partitioned operator A2 404 accesses and link 454 to pTensor 410. Such separation allows developers to flexibly perform op-trans on different operators in the DFG. Moreover, developers do not need to align tensors between adjacent operators during transformation, e.g., aligning vTensor3 440 and vTensor4 450 with vTensor2 430, leaving such a tedious and error-prone process to the phase of data dependency materialization.

Data Dependency Tracking Through vTensor

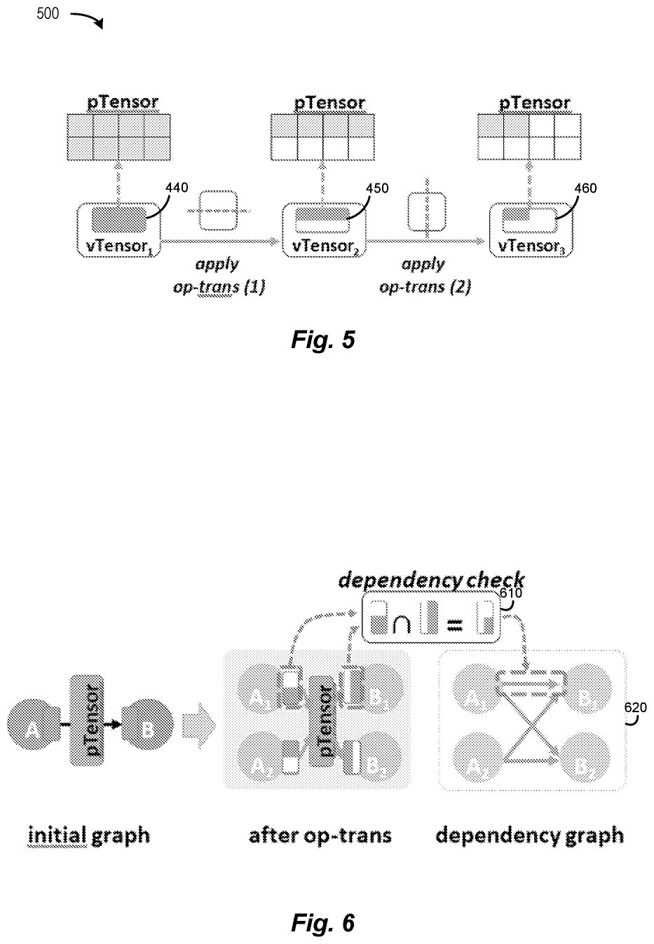

In some embodiments, PPG can track data dependency during operator transformations through the use of vTensor, the vTensor's link to pTensor, and the mask in vTensor, When op-trans partitions a vTensor into multiple vTensors, each new vTensor links to the same pTensor as the original vTensor but with a different mask. As described above, the mask identifies which portion of the pTensor that is accessed by the operator. FIG. 5 illustrates a process of tracking data dependency after two op-trans according to some embodiments. In process 500, the original vTensor1 maintains mask 440 which means that it is connected to an operator that accesses all of the pTensor. Here, the pTensor is illustrated as a 4×2 matrix. Applying op-trans (1) results in the original vTensor1 being partitioned horizontally. As shown, the partitioned operator after op-trans1 accesses the top half of the pTensor. As a result, op-trans1 partitions the tensor horizontally, the resulting vTensor2 maintaining a mask 450 to show it accesses the top half of vTensor1 to the pTensor. Op-trans (2) further partitions vTensor2 vertically, turning it into vTensor3, whose mask 460 indicates that the left half of vTensor2, which is the top-left part of pTensor is being accessed by the partitioned operator created by op-trans (2). For two vTensors linked to the same pTensor, PPG can easily detect whether they have data dependency by intersecting their masks. Such logical dependency may be used for space-time scheduling and dependency materialization.

### Space-Time Scheduling

In some embodiments, two primitives op-assign (op,device) and op-order (op1,op2) are utilized to enable flexible space-time scheduling. For example, op-assign (op1, GPU0) assigns computing device GPU0 to execute operator op1. PPG may record such assignment by annotating the DFG, which will be enforced during execution. After the assignment, the corresponding input and output tensors of the assigned operators naturally co-locate on the same computing device. Op-order (op1, op2) adds a happen-before edge in the PPG graph between the two operator nodes, and will perform op1 computation before op2 during execution.

Due to the freedom of arbitrary order specifying, it is possible that some op-order calls may violate previous op-orders or data dependency and cause deadlock. Deadlock is defined as when a group of processes or threads are unable to proceed because they are waiting for each other to release some resources. In the context of neural networks, deadlock may occur when operators are scheduled in an order where one or more operators are unable to complete because the operator depends on another operator that has not been performed yet. For example, let's assume device 0 schedules operator 1 to execute before operator 2. Similarly, device 1 schedules operator 3 to execute before operator 4. If operator 1 depends on the output of operator 4 and operator 3 depends on the output of operator 2, then we will have deadlock because operators 1 and 3 will never complete because they depend on the output of operators 4 and 2, respectively but operators 4 and 2 are scheduled after completion of operators 1 and 3. If instead operator 2 is scheduled before operator 1, then there won't be deadlock since operator 3 can execute to completion after operator 2 has been executed. To avoid potential deadlock and keep scheduling plans feasible, PPG may perform scheduling validation as follows. First, for each pair of producer and consumer operators in the initial graph, PPG performs an interaction over their vTensor masks. Non-empty intersections indicate the existence of data dependency. FIG. 6 illustrates an example of generating a dependency graph according to some embodiments. As shown, the initial graph includes pTensor as an output of operator A and an input of operator B. After op-trans, operator A has been transformed into partitioned operators A0 and A1. Operator A0 has an output vTensor with a mask of the bottom half of the pTensor. Similarly, operator A1 has an output vTensor with a mask of the top half of the pTensor. After another op-trans, operator B has also been transformed into partitioned operators B0 and B1. Operator B0 has an input vTensor with a mask of the right half of the pTensor. Similarly, operator B1 has an input vTensor with a mask of the left half of the pTensor. As shown, operators A1, A2, B1, and B2 all access the same pTensor. PPG can generate a dependency graph by performing a dependency check for each edge between the nodes in the graph. As shown in FIG. 6, PPG can perform dependency check 610 on the masks of the vTensors that belong to the output of A0 and the input of B0. The intersection of the mask of the bottom half of pTensor with the right half of pTensor results in an overlap in the bottom right quadrant, signifying that there is a data dependency here. A similar dependency check can be performed for the other vTensor pairs. A vTensor pair is a pair of vTensors where data output from one operator is input into another operator. Dependency graph 620 can identify all data dependencies after op transformation and scheduling. As shown here, there is a data dependency between vTensor pairs A0-B0, A0-B1, A1-B0, and A1-B1. With the identified data dependencies and the “happen-before” relations as edges, PPG can build dependency graph 620. In one embodiment, execution scheduling is feasible if it is an acyclic graph, which can be checked with graph circle detection algorithms. In certain cases, such as replicated producers, the consumer may depend on any one of the producers. PPG will enumerate these possibilities and consider the scheduling feasible if at least one acyclic graph exists. In some cases, the operator execution order on one device is unspecified, introducing ambiguity. To avoid potential deadlock due to ambiguous execution, PPG may specify a feasible order for these operators by applying a topological sort over the full dependency graph and returning the global sequential order. The topological sort algorithm takes a directed graph and returns an array of the nodes where each node appears before all the nodes it points to. In some embodiments, any particular topological sort algorithm can be used here, e.g., Topological Sorting of Large Networks, Efficient Parallel and Distributed Topological Sort Algorithms, A Parallel Computation Approach to Topological Sorting. In other embodiments, other sorting algorithms may be applied.

### Dependency Materialization

After transformation and scheduling, operators in the resulting DFG may have some upstream output vTensor mismatched its downstream input vTensor (i.e., cannot directly handover without repartition), or located in different computing devices. Data dependency materialization may be utilized to address these problems with the following steps. Producer vTensors are also known as output vTensors that are produced by an operator. Similarly, consumer vTensors are also known as input vTensors that are consumed by an operator.

Data dependency materialization may first identify the non-empty overlapped portions of input/output vTensors pairs by intersecting the masks in vTensor pairs to identify the intersection or overlap. Second, for the producer vTensor, a split operator is inserted to extract the overlapped portion of the two vTensors that are consumed in the input vTensor. A pair of send-receive operators can be inserted if the two vTensors locate in different devices so that the vTensor is available on the consumer vTensor's computing device. Finally, a concat or reduce operator on the consumer side is inserted to construct an input vTensor with the desired mask from multiple producers.

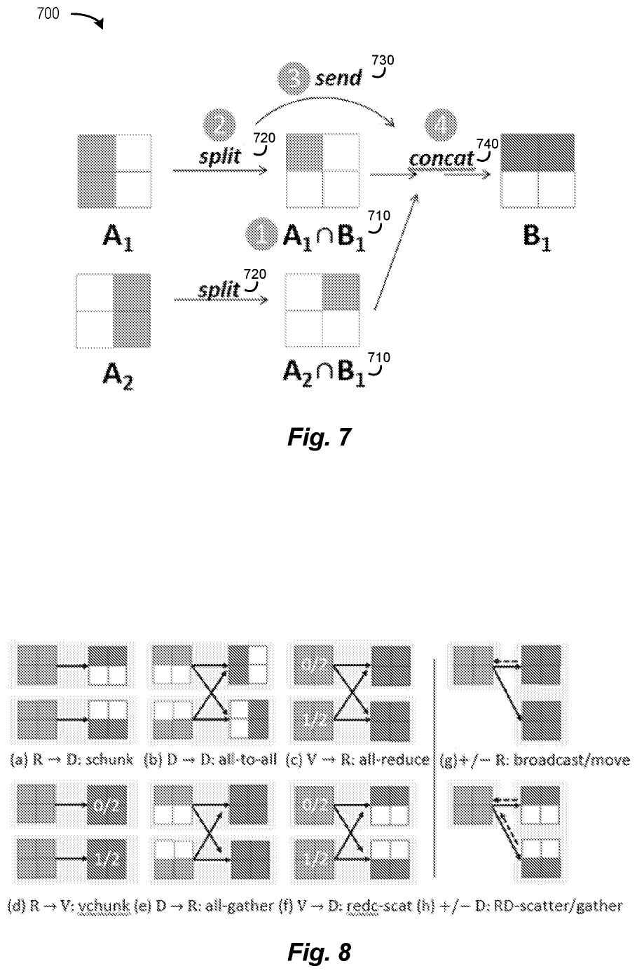

FIG. 7 illustrates a process of data dependency materialization according to some embodiments. As shown, operator A1 includes a producer vTensor having a mask of the left half of the pTensor, operator A2 includes a producer vTensor having a mask of the right half of the pTensor, and operator B1 includes a consumer vTensor having a mask of the top half of the pTensor. Process 700 starts by determining the overlapped regions at step 710. The overlapped region A1∩B1 is the top-left quadrant and the overlapped region A2∩B1 is the top-right quadrant. Process 700 then splits both A1 and A2 to extract the overlapped region at step 720. In some examples where there are crossdevice vTensors (i.e., vTensors are on different computing devices), a communication operation may move the split vTensors to the same device at step 730. Crossdevice vTensors exists when there is a pair of a producer vTensor and a consumer vTensor that are located on different devices and where the consumer vTensor consumes a portion of data from the producer vTensor and the producer vTensor. In one example, the communication operator performs a send/receive operation. Finally, on the receiver side (also known as the computing device hosting the producer vTensor), process 700 concats the collected split vTensors as vTensor B1 at step 740. The changes will be recorded in the DFG for later code generation. During materialization, there exist optimization opportunities for communications.

### Exploring More Parallelization Plans

With the above design, PPG can support existing popular parallelization plans as well as new flexible parallelization plans for emerging models.

Algorithm 1 below shows an example program for data parallelism. It takes a DFG and device environment as input. Each forward computation operator will be partitioned along the “batch” dimension with op-trans (Line 3-5). The batch dimension is a dimension in a high dimensional tensor that partitioning along will split the data from different samples. The other optimizer operators will be replicated (Line 6-7). Then the transformed operators will be assigned among devices (Line 8-9). The operator type and dimension information used in IsForward and GetBatchDim( ) are captured from DFG and kept in DFG. Note that backward operators can be omitted in the specification, DFG may adapt them to their forward operators automatically through operator transformation.

Algorithm 1: Data Parallelism Program

| | Input: CubePlannerGraph g, Environment env | | | |
|---|---|---|---|---|
| | Output: transformed CubePlannerGraph g | | | |
| 1 | ndevs ← \|env.devices\| | | | // get device number |
| 2 | for op ∈ g.ops do | | | |
| 3 | \| | if IsForward(op) then | | // partition forward ops |
| 4 | \| | \| | dim ← GetBatchDim(op) | |
| 5 | \| | \| | new_ops ← op-trans(op, SplitAlgo(dim, ndevs)) | |
| 6 | \| | else | | // replicate optimizer |
| 7 | \| | \| | new_ops ← op-trans(op, ReplicaAlgo(ndevs)) | |
| | \| | └ | | |
| 8 | \| | for new_op, device in zip(new_ops, env.devices) do | | |
| 9 | \| | \| | op-assign(new_op, device) | |
| | └ | └ | | |

mBART is a language translation model with imbalance layers. It consists of embedding layers and transformer layers. The embedding layers consume large memory with little computation load, while the transformer layers are opposite, leading to imbalance resource utilization if organizing the layers into stages. Existing pipeline parallelisms can place different stages on disjoint devices. Such parallelization plan will lead to low resource utilization due to imbalanced resource consumption across stages. To tailor a parallelization plan for this model, we break the assumption of existing pipeline parallelisms that the stages shall be placed on disjoint devices. To this end, the embedding layer as the first pipeline stage shares the devices with all other stages. A program for Interlaced Pipeline is more complex than existing pipeline parallelisms. Algorithm 2 below is an example program for interlaced pipeline parallelism. The program first transforms the graph to K micro-batches (Line 2-3). It places transformer operators (i.e., stage_ops) to different devices (Line 6-8). Then, for embedding layers (i.e., emb_ops), it further splits it into S partitions and places them across all devices (Line 10-13). After operator transformation and placement, the program works on the temporal scheduling (Line 13-22). Transformer operators (i.e., stage_ops) are firstly reordered to follow the same temporal order of 1F1B pipeline into a sequence of stage tasks (Line 13). Then inside a “for” loop, op-order is applied to determine such sequential temporal ordering (Line 15-18). Embedding operators (i.e., embed_tasks) are inserted as barriers among transformer operators when the step is a multiple of 2 (Line 19-22).

Algorithm 2: Interlaced Pipeline Parallelism

| Input: SuperScalerGraph g, Environment env, Micro Batch | |
|---|---|
| | Number K |

| | | |
|---|---|---|
| 1 | S ← \|env.devices\| | // number of stages |

| | // ==== 1F18 Transformation | |
|---|---|---|
| 2 | | for op ∈ g.ops do |
| 3 | \| | dim ← GetBatchDim(op) |
| 4 | └ | op-trans(op, SplitAlgo(dim, K)) |
| 5 | | emb_ops, stage_ops ← Classify(g.ops) |
| 6 | \| | for sid ← 1 to S do |
| 7 | \| | ops ← GetStageOps(stage_ops, sid) |
| | └ | |
| 8 | | op-assign(ops, sid) |
| | // ==== Additional transformation | |
| 9 | \| | for op ∈ emb_ops do |
| 10 | \| | ops ← op-trans(op, ShardEmbedAlgo(S)) |
| 11 | └ | for device ∈ 1 to S do |

12OP-assign(ops[device], device)

| | // ==== interlaced Pipeline Scheduling | | | |
|---|---|---|---|---|
| 13 | | | tasks ← OrderTo1F1B(stage_ops) | |
| 14 | | | previous_tasks ← GetEmbedTasks(emb_ops, 0) | |
| 15 | | | for step ← 1 to 2*(S+K−1) do | |
| 16 | \| | | stage_tasks ← PopHeadFromTasks(tasks) | |
| 17 | \| | | op-order(previous_tasks, stage_tasks) | |
| 18 | \| | | previous_tasks ← stage_tasks | |
| 19 | \| | | if step % 2 = 0 then | |
| 20 | \| | \| | embed_tasks ← GetEmbedTasks(emb_ops, step) | |
| 21 | \| | \| | op-order(stage_tasks, embed_tasks) 22 | |
| | └ | \| | | previous_tasks ← embed_tasks |

### Communication Optimization

In some embodiments, the more flexible parallelization plans may introduce more diverse and unconventional communication patterns. During data dependency materialization, PPG may optimize communications in one or more of the following ways.

Aligning with efficient communication collectives-Modern communication libraries usually provide highly efficient, MPI-like collective communication interfaces, e.g., broadcast, gather, reduce and all-reduce, which often outperform the peer-to-peer send and receive interfaces. Hence PPG analyzes the data dependency graph and performs a pattern match to replace a group of peer-to-peer communications into high-performance collectives. For complex communication patterns that cannot match any single interface, an algorithm to compose the communication with multiple communication primitives based on RVD representation may be designed.

RVD representation-DNN clusters are usually equipped with homogeneous accelerator devices. Therefore, most parallelization plans partition operators evenly. Thus, their input or output tensors can be simply expressed as: 1) R (i), the tensor is replicated to i copies; 2) V (j), value split, the tensor is decomposed to j copies with the same shape; 3) D (k1, k2, . . . , kn), uniformly partition the tensor into k1 parts in the first dimension, k2 parts in the second dimension, so on so forth. We use RVD to denote the transformation of a tensor. For example, R(1)V(2)D(1,2) indicates a 2-D pTensor requires no replication, is decomposed into 2 vTensors with the same shape, and each is partitioned into 2 vTensors by partitioning the second axis. Thus, R(1)V(2)D(1,2) can represent 4 vTensors. RVD can represent both producer vTensors and consumer vTensors as they are both transformed from the pTensor.

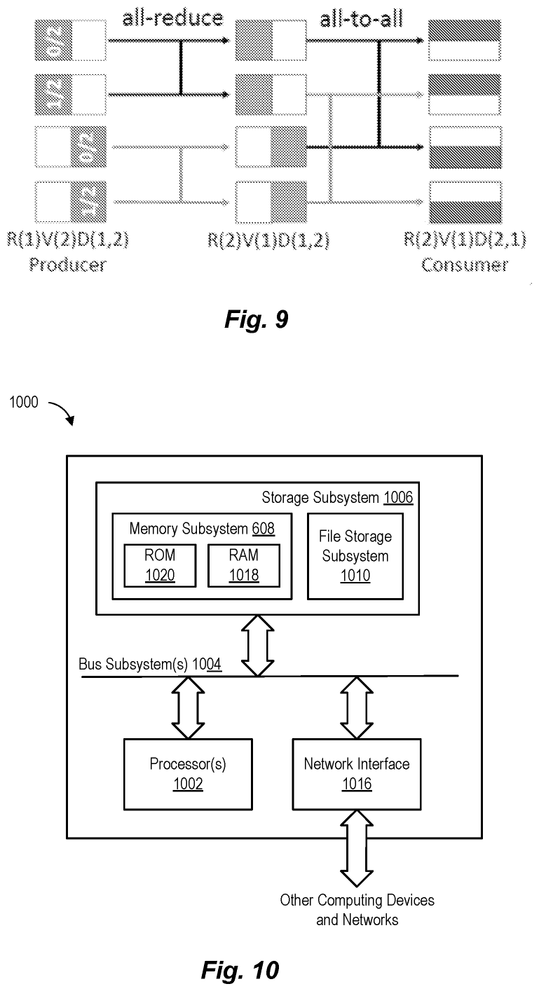

Communication primitive search over RVD graph-Applying a communication primitive essentially turns an RVD to another, with a specific element-wise value exchange pattern (e.g., all-to-all or all-reduce). Thus, a communication primitive defines an RVD transition rule. FIG. 8 illustrates communication primitives with producers and consumers on the same group of devices according to some embodiments. These communication primitives can be translated into the value changes between R, V, and D (i/j in box indicating value split into j parts and this is i-th part). With the transition rules for different communication primitives as edges, a RVD transition graph can be built, and turn the communication composing problem into a problem to find a path from the producer RVD to the consumer RVD. FIG. 9 illustrates an example that connects the producer R(1)V(2)D(1,2) to the consumer R(2)V(1)D(2,1). It first performs an all-reduce over every 2 tensors to turn V(2) into R(2), and gets R(2)V(1)D(1,2). Then with an all-to-all applied on every two tensors, it converts R(2)V(1)D(1,2) into R(2)V(1)D(2,1). The above solution targets consumer and producer located in the same group of devices, namely intra-device-group RVD, or intra-RVD for short. It's also possible that producers and consumers locate on different groups of devices, namely inter-RVD. For interRVD, it first follows the above procedure to build RVD graphs for consumers and producers, respectively. Then it connects the 2 RVD graphs with extended primitives in FIG. 8 (g and h) as cross-graph edges, and forms a larger graph. We assign the edge weight with the time of the communication primitive and leverage Dijkstra algorithm to search the shortest path from producer RVD to consumer RVD, and translate the path into a sequence of communication primitives. This approach can accommodate new communication primitives by formulating a new RVD transition graph.

FIG. 10 depicts a simplified block diagram of an example computer system 1000, which can be used to implement some of the techniques described in the foregoing disclosure. As shown in FIG. 10, system 1000 includes one or more processors 1002 that communicate with a number of devices via one or more bus subsystems 1004. These devices may include a storage subsystem 1006 (e.g., comprising a memory subsystem 1008 and a file storage subsystem 1010) and a network interface subsystem 1016. Some systems may further include user interface input devices and/or user interface output devices (not shown).

Bus subsystem 1004 can provide a mechanism for letting the various components and subsystems of system 1000 communicate with each other as intended. Although bus subsystem 1004 is shown schematically as a single bus, alternative embodiments of the bus subsystem can utilize multiple busses.

Network interface subsystem 1016 can serve as an interface for communicating data between system 1000 and other computer systems or networks. Embodiments of network interface subsystem 1016 can include, e.g., Ethernet, a Wi-Fi and/or cellular adapter, a modem (telephone, satellite, cable, etc.), and/or the like.

Storage subsystem 1006 includes a memory subsystem 1008 and a file/disk storage subsystem 1010. Subsystems 1008 and 1010 as well as other memories described herein are examples of non-transitory computer-readable storage media that can store executable program code and/or data that provide the functionality of embodiments of the present disclosure.

Memory subsystem 1008 comprise one or more memories including a main random access memory (RAM) 1018 for storage of instructions and data during program execution and a read-only memory (ROM) 1020 in which fixed instructions are stored. File storage subsystem 1010 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 1000 is illustrative and many other configurations having more or fewer components than system 1000 are possible.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a system for generating a parallelization plan for a Neural Network (NN) model comprising one or more processors, a non-transitory computer-readable medium storing a program executable by the one or more processors, the program comprising sets of instructions for: receiving a data flow graph representing the NN model, wherein the data flow graph includes a first operator having an input tensor and an output tensor, transforming the data flow graph, wherein transforming the data flow graph includes transforming the first operator into a set of operators that are functionally equivalent to the first operator, and assigning each operator in the set of operators to a computing device from a plurality of computing devices that are part of an execution environment configured to execute the NN model.

In one embodiment, transforming the data flow graph further includes generating, for each operator in the set of operators, a virtual input tensor that links to the input tensor and a virtual output tensor that links to the output tensor.

In one embodiment, the virtual input tensor includes an input mask representing a portion of the input tensor that an operator from the set of operators accesses.

In one embodiment, the virtual output tensor includes an output mask representing a portion of the output tensor that the operator from the set of operators accesses

In one embodiment, the program further comprises sets of instructions for: identifying a plurality of virtual input tensors that are linked to the input tensor and a plurality of virtual output tensors that are linked to the input tensor; and determining a data dependency exists between a first virtual input tensor from the plurality of virtual input tensors and a first virtual output tensor from the plurality of virtual output tensors.

In one embodiment, data dependency is determined when there is an overlap between the masks of the first virtual input tensor and the first virtual output tensor.

In one embodiment, the program further comprises sets of instructions for determining an execution order for the set of operators based on the data dependency.

In one embodiment, the first virtual input tensor is stored in a first computing device and the first virtual output tensor is stored in a second computing device, and wherein the program further comprises sets of instructions for sending a portion of the first virtual output tensor from the second computing device to the first computing device based on the data dependency.

In one embodiment, the portion based on the overlap.

In one embodiment, transforming the first operator comprises partitioning the first operator into the set of operators based on a batch dimension of the first operator and a count of the plurality of computing devices when the first operator is a forward operation.

In one embodiment, transforming the first operator comprises replicating the first operator into the set of operators when the first operator is not a forward operation.

In some embodiments, the present disclosure includes a method for generating a parallelization plan for a Neural Network (NN) model comprises: receiving a data flow graph representing the NN model, wherein the data flow graph includes a first operator having an input tensor and an output tensor; transforming the data flow graph, wherein transforming the data flow graph includes transforming the first operator into a set of operators that are functionally equivalent to the first operator; and assigning each operator in the set of operators to a computing device from a plurality of computing devices that are part of an execution environment configured to execute the NN model.

In some embodiments, the present disclosure includes a non-transitory computer-readable medium storing a program executable by one or more processors, the program comprising sets of instructions for: receiving a data flow graph representing the NN model, wherein the data flow graph includes a first operator having an input tensor and an output tensor; transforming the data flow graph, wherein transforming the data flow graph includes transforming the first operator into a set of operators that are functionally equivalent to the first operator; and assigning each operator in the set of operators to a computing device from a plurality of computing devices that are part of an execution environment configured to execute the NN model.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A system for generating a parallelization plan for a Neural Network (NN) model comprising:
one or more processors;
a non-transitory computer-readable medium storing a program executable by the one or more processors, the program comprising sets of instructions for:
receiving a data flow graph representing the NN model, wherein the data flow graph includes a first operator having an input tensor and an output tensor;
transforming the data flow graph, wherein transforming the data flow graph includes transforming the first operator into a set of operators that are functionally equivalent to the first operator; and
assigning each operator in the set of operators to a computing device from a plurality of computing devices that are part of an execution environment configured to execute the NN model.

2. The system of claim 1, wherein transforming the data flow graph further includes generating, for each operator in the set of operators, a virtual input tensor that links to the input tensor and a virtual output tensor that links to the output tensor.

3. The system of claim 2, wherein the virtual input tensor includes an input mask representing a portion of the input tensor that an operator from the set of operators accesses.

4. The system of claim 3, wherein the virtual output tensor includes an output mask representing a portion of the output tensor that the operator from the set of operators accesses.

5. The system of claim 4, wherein the program further comprises sets of instructions for:
identifying a plurality of virtual input tensors that are linked to the input tensor and a plurality of virtual output tensors that are linked to the input tensor; and
determining a data dependency exists between a first virtual input tensor from the plurality of virtual input tensors and a first virtual output tensor from the plurality of virtual output tensors.

6. The system of claim 5, wherein data dependency is determined when there is an overlap between the masks of the first virtual input tensor and the first virtual output tensor.

7. The system of claim 5, wherein the program further comprises sets of instructions for determining an execution order for the set of operators based on the data dependency.

8. The system of claim 5, wherein the first virtual input tensor is stored in a first computing device and the first virtual output tensor is stored in a second computing device, and wherein the program further comprises sets of instructions for sending a portion of the first virtual output tensor from the second computing device to the first computing device based on the data dependency.

9. The system of claim 8, wherein the portion based on the overlap.

10. The system of claim 1, wherein transforming the first operator comprises partitioning the first operator into the set of operators based on a batch dimension of the first operator and a count of the plurality of computing devices when the first operator is a forward operation.

11. The system of claim 1, wherein transforming the first operator comprises replicating the first operator into the set of operators when the first operator is not a forward operation.

12. A method for generating a parallelization plan for a Neural Network (NN) model comprising:
receiving a data flow graph representing the NN model, wherein the data flow graph includes a first operator having an input tensor and an output tensor;
transforming the data flow graph, wherein transforming the data flow graph includes transforming the first operator into a set of operators that are functionally equivalent to the first operator; and
assigning each operator in the set of operators to a computing device from a plurality of computing devices that are part of an execution environment configured to execute the NN model.

13. The method of claim 12, wherein the virtual input tensor includes an input mask representing a portion of the input tensor that an operator from the set of operators accesses and an output mask representing a portion of the output tensor that the operator from the set of operators accesses.

14. The method of claim 13, further comprising:
identifying a plurality of virtual input tensors that are linked to the input tensor and a plurality of virtual output tensors that are linked to the input tensor; and
determining a data dependency exists between a first virtual input tensor from the plurality of virtual input tensors and a first virtual output tensor from the plurality of virtual output tensors.

15. The method of claim 14, wherein data dependency is determined when there is an overlap between the masks of the first virtual input tensor and the first virtual output tensor.

16. The method of claim 14, wherein the program further comprises sets of instructions for determining an execution order for the set of operators based on the data dependency.

17. The method of claim 14, wherein the first virtual input tensor is stored in a first computing device and the first virtual output tensor is stored in a second computing device, and wherein the program further comprises sets of instructions for sending a portion of the first virtual output tensor from the second computing device to the first computing device based on the data dependency.

18. The method of claim 12, wherein transforming the first operator comprises partitioning the first operator into the set of operators based on a batch dimension of the first operator and a count of the plurality of computing devices when the first operator is a forward operation.

19. The method of claim 12, wherein transforming the first operator comprises replicating the first operator into the set of operators when the first operator is not a forward operation.

20. A non-transitory computer-readable medium storing a program executable by one or more processors, the program comprising sets of instructions for:
receiving a data flow graph representing the NN model, wherein the data flow graph includes a first operator having an input tensor and an output tensor;
transforming the data flow graph, wherein transforming the data flow graph includes transforming the first operator into a set of operators that are functionally equivalent to the first operator; and
assigning each operator in the set of operators to a computing device from a plurality of computing devices that are part of an execution environment configured to execute the NN model.
